(19) United States
(12) Patent Application Publication
(10) Pub. No.: US 2013/0077078 A1
(43) Pub. Date: Mar. 28, 2013

(54) Lithographic Apparatus and Substrate Handling Method

(71) Applicants: Raymond Wilhelmus Louis LAFARRE, Helmond (NL); Sjoerd Nicolaas Lambertus Donders, Vught (NL); Antonius Franciscus Johannes De Groot, Somerren (NL); Hubert Marie Segers, 's-Hertogenbosch (NL); Johannes Petrus Martinus Bernardus Vermeulen, Helmond (NL); Raimond Visser, Best (NL); Johannes Charles Adrianus Van Den Berg, Prinsenbeek (NL); Jan Steven Christiaan Westerlaken, Heesch (NL); Yang-Shan Huang, Veldhoven (NL); Christiaan Louis Valentin, Eindhoven (NL)

(72) Inventors: Raymond Wilhelmus Louis LAFARRE, Helmond (NL); Sjoerd Nicolaas Lambertus Donders, Vught (NL); Antonius Franciscus Johannes De Groot, Somerren (NL); Hubert Marie Segers, 's-Hertogenbosch (NL); Johannes Petrus Martinus Bernardus Vermeulen, Helmond (NL); Raimond Visser, Best (NL); Johannes Charles Adrianus Van Den Berg, Prinsenbeek (NL); Jan Steven Christiaan Westerlaken, Heesch (NL); Yang-Shan Huang, Veldhoven (NL); Christiaan Louis Valentin, Eindhoven (NL)

(73) Assignee: ASML Netherlands B.V., Veldhoven (NL)

(21) Appl. No.: 13/597,831

(22) Filed: Aug. 29, 2012

Related U.S. Application Data
(60) Provisional application No. 61/538,612, filed on Sep. 23, 2011.
(60) Provisional application No. 61/547,220, filed on Oct. 14, 2011.

(51) Int. Cl. G03B 27/58

(52) U.S. Cl. 355/72

(57) ABSTRACT

A lithographic apparatus comprises a substrate table constructed to hold a substrate and a gripper arranged to position the substrate on the substrate table. The gripper includes an electrostatic clamp arranged to clamp the substrate at a top side thereof. The electrostatic clamp is arranged to clamp at least part of a circumferential outer zone of a top surface of the substrate. The invention provides a substrate handling method including positioning the substrate by means of a gripper on a substrate table of a lithographic apparatus. The substrate is clamped at a top side thereof by using an electrostatic clamp of the gripper.

This application claims the benefit under 35 U.S.C. §119(e) to U.S. Provisional Patent Application No. 61/538,612, filed Sep. 23, 2011 and U.S. Provisional Patent Application No. 61/547,220, filed Oct. 14, 2011, which are incorporated by reference herein in their entirety.

### BACKGROUND

1. Field of the Invention

The invention relates to a lithographic apparatus, a substrate handling method and a substrate handler.

2. Description of the Related Art

A lithographic apparatus is a machine that applies a desired pattern onto a substrate, usually onto a target portion of the substrate. A lithographic apparatus can be used, for example, in the manufacture of integrated circuits (ICs). In such a case, a patterning device, which is alternatively referred to as a mask or a reticle, may be used to generate a circuit pattern to be formed on an individual layer of the IC. This pattern can be transferred onto a target portion (e.g., including part of, one, or several dies) on a substrate (e.g., a silicon wafer). Transfer of the pattern is typically via imaging onto a layer of radiation-sensitive material (resist) provided on the substrate. In general, a single substrate will contain a network of adjacent target portions that are successively patterned. Conventional lithographic apparatus include so-called steppers, in which each target portion is irradiated by exposing an entire pattern onto the target portion at once, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

A wafer handler system transports a substrate (e.g., a wafer) into a substrate table compartment (e.g., a wafer stage compartment). The substrate is positioned by a gripper of the handler above the substrate table and pins projecting from the substrate table take over the wafer. When the gripper is retrieved the pins move down and load the wafer onto the wafer table.

When the wafer is loaded on the wafer table, stresses may be introduced in the wafer because of friction between burls of the wafer table and the wafer. These stresses may lead to wafer deformation and consequential projection errors.

### SUMMARY

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

It is desirable to position a substrate onto the substrate table with a low stress.

According to an embodiment of the invention, there is provided a lithographic apparatus arranged to transfer a pattern from a patterning device onto a substrate, the lithographic apparatus comprising: a substrate table constructed to hold a substrate; and a gripper arranged to position the substrate on the substrate table, the gripper comprising an electrostatic clamp arranged to clamp the substrate at a top side thereof, wherein a stiffness of the clamp is lower than an average stiffness of the to be gripped substrate.

According to another embodiment of the invention, there is provided a substrate handling method comprising positioning the substrate by means of a gripper on a substrate table of a lithographic apparatus, the method comprising clamping the substrate at a top side thereof by means of an electrostatic clamp of the gripper, wherein a stiffness of the clamp is lower than an average stiffness of the to be gripped substrate.

According to yet another embodiment of the invention there is provided a substrate handler for handling a substrate, the substrate handler comprising a gripper for gripping the substrate and positioning the substrate on a substrate table, wherein the gripper comprises an electrostatic clamp arranged to clamp the substrate at a top side thereof, wherein a stiffness of the clamp is lower than an average stiffness of the to be gripped substrate.

Further features and advantages of the invention, as well as the structure and operation of various embodiments of the present invention, are described in detail below with reference to the accompanying drawings. The invention is not limited to the specific embodiments described herein. Such embodiments are presented herein for illustrative purposes only. Additional embodiments will be apparent to persons skilled in the relevant art(s) based on the teachings contained herein. The Summary and Abstract sections of this patent document may describe one or more, but not all exemplary embodiments of the invention as contemplated by the inventor(s).

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention. In the drawings, like reference numbers may indicate identical or functionally similar elements. The drawing in which an element first appears is generally indicated by the left-most digit in the corresponding reference number. The accompanying drawings, which are incorporated in and constitute part of the specification, illustrate embodiments of the invention and, together with the general description given above and the detailed descriptions of embodiments given below, serve to explain the principles of the present invention. Embodiments of the invention will now be described, by way of example only, with reference to the accompanying schematic drawings in which corresponding reference symbols indicate corresponding parts, and in which:

FIG. 1 depicts a lithographic apparatus in which an embodiment of the invention may be provided;

FIG. 2 depicts a schematic, partly cross sectional side view of a part of a gripper according to an embodiment of the invention;

FIGS. 3A-3C each depict a schematic top view of an electrode configuration of a gripper according to embodiments of the invention.

FIG. 4 depicts a schematic view of a gripper according to an embodiment of the invention.

FIGS. 5A-5C depict a schematic view of a gripper according to embodiments of the invention.

FIGS. 6A-6D depict a schematic view of a buffer according to an embodiment of the invention.

Features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It should be understood that spatial descriptions (e.g., “above,” “below,” “left,” “right,” “up,” “down,” “top,” “bottom,” etc.) used herein are for purposes of illustration only, and that practical implementations of the structures described herein can be spatially arranged in any orientation or manner.

The invention will be better understood from the following descriptions of various embodiments of the invention. Thus, specific embodiments are views of the invention, but each does not itself represent the whole invention. In many cases individual elements from one particular embodiment may be substituted for different elements in another embodiment carrying out a similar or corresponding function.

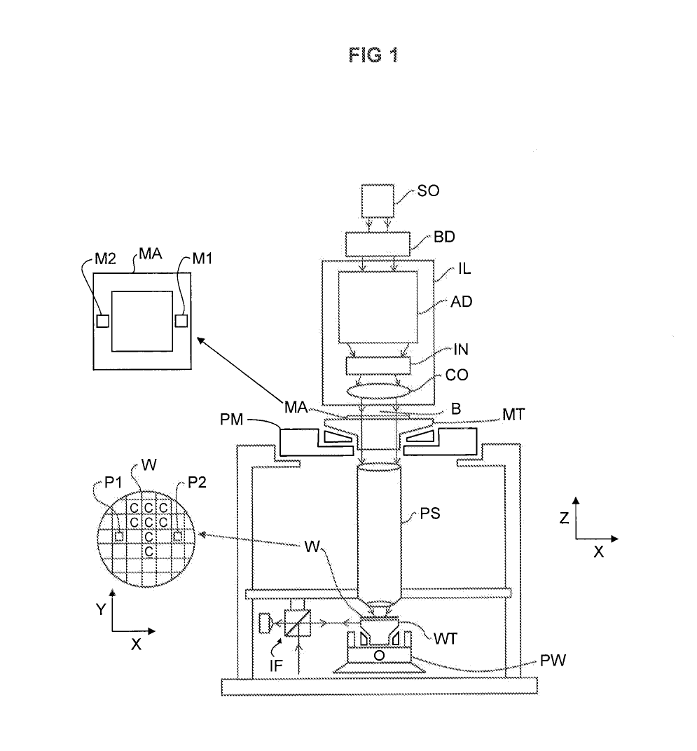

FIG. 1 schematically depicts a lithographic apparatus according to an embodiment of the invention. The apparatus includes an illumination system (illuminator) IL configured to condition a radiation beam B (e.g., UV radiation or any other suitable radiation), a mask support structure (e.g., a mask table) MT constructed to support a patterning device (e.g., a mask) MA and connected to a first positioning device PM configured to accurately position the patterning device in accordance with certain parameters. The apparatus also includes a substrate table (e.g., a wafer table) WT or “substrate support” constructed to hold a substrate (e.g., a resist-coated wafer) W and connected to a second positioning device PW configured to accurately position the substrate in accordance with certain parameters. The apparatus further includes a projection system (e.g., a refractive projection lens system) PS configured to project a pattern imparted to the radiation beam B by patterning device MA onto a target portion C (e.g., including one or more dies) of the substrate W.

The illumination system may include various types of optical components, such as refractive, reflective, magnetic, electromagnetic, electrostatic or other types of optical components, or any combination thereof, for directing, shaping, or controlling radiation.

The mask support structure supports, i.e., bears the weight of, the patterning device.

It holds the patterning device in a manner that depends on the orientation of the patterning device, the design of the lithographic apparatus, and other conditions, such as for example whether or not the patterning device is held in a vacuum environment. The mask support structure can use mechanical, vacuum, electrostatic or other clamping techniques to hold the patterning device. The mask support structure may be a frame or a table, for example, which may be fixed or movable as required. The mask support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section so as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is-reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system.”

As here depicted, the apparatus is of a transmissive type (e.g., employing a transmissive mask). Alternatively, the apparatus may be of a reflective type (e.g., employing a programmable mirror array of a type as referred to above, or employing a reflective mask).

The lithographic apparatus may be of a type having two (dual stage) or more substrate tables or “substrate supports” (and/or two or more mask tables or “mask supports”). In such “multiple stage” machines the additional tables or supports may be used in parallel, or preparatory steps may be carried out on one or more tables or supports while one or more other tables or supports are being used for exposure.

The lithographic apparatus may also be of a type wherein at least a portion of the substrate may be covered by a liquid having a relatively high refractive index, e.g., water, so as to fill a space between the projection system and the substrate. An immersion liquid may also be applied to other spaces in the lithographic apparatus, for example, between the mask and the projection system. Immersion techniques can be used to increase the numerical aperture of projection systems. The term “immersion” as used herein does not mean that a structure, such as a substrate, must be submerged in liquid, but rather only means that a liquid is located between the projection system and the substrate during exposure.

Illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD including, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may include an adjuster AD configured to adjust the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may include various other components, such as an integrator IN and a condenser CO. The illuminator may be used to condition the radiation beam, to have a desired uniformity and intensity distribution in its cross-section.

The radiation beam B is incident on the patterning device (e.g., mask MA), which is held on the mask support structure (e.g., mask table MT), and is patterned by the patterning device. Having traversed the mask MA, the radiation beam B passes through the projection system PS, which focuses the beam onto a target portion C of the substrate W. With the aid of the second positioning device PW and position sensor IF (e.g., an interferometric device, linear encoder or capacitive sensor), the substrate table WT can be moved accurately, e.g., so as to position different target portions C in the path of the radiation beam B. Similarly, the first positioning device PM and another position sensor (which is not explicitly depicted in FIG. 1) can be used to accurately position the mask MA with respect to the path of the radiation beam B, e.g., after mechanical retrieval from a mask library, or during a scan. In general, movement of the mask table MT may be realized with the aid of a long-stroke module (coarse positioning) and a short-stroke module (fine positioning), which form part of the first positioning device PM. Similarly, movement of the substrate table WT or “substrate support” may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT or “mask support” and the substrate table WT or “substrate support” are kept essentially stationary, while an entire pattern imparted to the radiation beam is projected onto a target portion C at one time (i.e., a single static exposure). The substrate table WT or “substrate support” is then shifted in the X and/or Y direction so that a different target portion C can be exposed. In step mode, the maximum size of the exposure field limits the size of the target portion C imaged in a single static exposure.

2. In scan mode, the mask table MT or “mask support” and the substrate table WT or “substrate support” are scanned synchronously while a pattern imparted to the radiation beam is projected onto a target portion C (i.e., a single dynamic exposure). The velocity and direction of the substrate table WT or “substrate support” relative to the mask table MT or “mask support” may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT or “mask support” is kept essentially stationary holding a programmable patterning device, and the substrate table WT or “substrate support” is moved or scanned while a pattern imparted to the radiation beam is projected onto a target portion C. In this mode, generally a pulsed radiation source is employed and the programmable patterning device is updated as required after each movement of the substrate table WT or “substrate support” or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

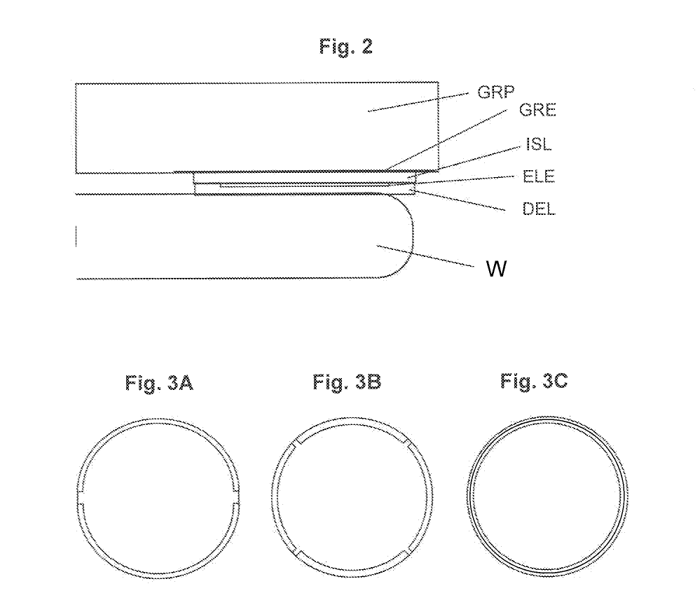

FIG. 2 depicts a part of a gripper body GRP arranged for gripping a substrate W, such as a wafer, part of which being depicted in FIG. 2. The substrate W is gripped at a top surface thereof. Thereto, the gripper comprises an electrostatic clamp which clamps the substrate at a top side thereof. As a result, conventional retractable pins that push the substrate upwards from the substrate table, so as to create a spacing between the substrate and the substrate table, the spacing to allow a gripper to grip the substrate at an underside thereof, may be avoided. Hence, the substrata table may be improved in terms of mass and rigidity. Furthermore, thermal spot effects that may occur as a result of a local contact of the pins with the substrate may be avoided.

In an embodiment, the electrostatic clamp is arranged to clamp the substrate along an outer edge thereof. By clamping (at least part of) a circumferential outer zone of the top surface of the substrate, also referred to as an exclusion area of the substrate, any effects (such as damage) on structures or patterns on the substrate may be avoided. Furthermore, as the clamp contacts a circumferential part or a segment of a circumferential part of the substrate surface, local thermal spot effects onto the substrate as a result of the heat-load from the gripper may be avoided. In case a thermal effect on the substrate occurs, its more global nature as a result of contacting the edge of the substrate, may have less effects and may more easily be compensated, for example by a suitable modeling. Still further, the substrate may be positioned on the substrate table involving little mechanical stress in the substrate. This is because clamping the substrate along the edge thereof allows to place the substrate onto the substrate table (e.g., onto burls of the substrate table) starting with a center of the substrate, due to some degree of bending of the substrate as a result of gravity force, followed by a contacting of the substrate circularly from the center towards the edge thereof, so that the substrate may be placed onto the burls with a low amount of mechanical stress. Furthermore, as the edge of the substrate, where the clamp contacts it, is commonly not supported by burls, any stresses imposed on the substrate by the clamp, may relax more freely, as the edge of the substrate us relatively free, even when positioned onto (e.g., the burls of) the substrate table.

The electrostatic clamp comprises an electrode ELE, and an isolation layer that isolates the electrode from the substrate, such as in this example the dielectric layer DEL. The dielectric and isolation layers may exhibit a low thermal conductivity thereby to further reduce a thermal coupling between the gripper and the substrate. A ground electrode GRE may be provided which may provide that the electrostatic field is shielded and/or kept in local area. The ground electrode GRE may, as depicted in FIG. 2, be positioned at a side of the electrode that faces away from the substrate, along a large surface of the ground electrode. The ground electrode may also be implemented as a concentric ring, for example coplanar with the electrode ELE and e.g., having a smaller diameter than the electrode, which may reduce an effect of the electrostatic field onto an inner part of the substrate. In the implementation depicted in FIG. 2, a isolation layer ISL is provided between the electrode and the ground layer.

A monopolar clamp may be provided (i.e., a clamp that applies a single voltage). In order to reduce an effect onto the substrate (e.g., charging of the substrate), a bipolar electrical clamp may be applied that comprises two electrodes, whereby two substantially opposite voltages are applied to the electrodes, which may reduce a effect of charging etc. onto the substrate.

FIG. 3A-3C depict embodiments of the electrode or electrodes of the electrostatic clamp. In FIG. 3A, two electrodes 302, 304 are provided that may provide a bipolar clamp when driven with opposite voltages. The electrodes each form a segment of approximately a half of a circle. Similarly, in FIG. 3B, four electrodes 306, 308, 310, 312 are provided that each form a segment of approximately a quarter of a circle. Two of the electrodes may be driven with a positive voltage and two with a negative voltage, so as to provide a bipolar clamp. In FIG. 3C, two concentric circular electrodes 314, 316 are provided. When driven with opposite voltages, a minimum effect (e.g., charge build up) on or in the substrate may result. Furthermore, a third, concentric electrode ring may be provided as a ground electrode. In each of the depicted embodiments, the electrostatic clamp only clamps the wafer along the edge thereof, along its circumference, thereby possibly providing one or more of the effects as explained above.

In the depicted embodiments, a thickness of the dielectric layer may be in an order of magnitude of 10 to 50 micrometers, so as to provide a reliable breakdown strength. In order to avoid an effect of an electrostatic field on a pattern or structure on the substrate (such as a semiconductor structure), a margin may be kept between an inner diameter of the electrodes and an outer diameter of the area of the substrate where the pattern is to be provided (e.g., the area of the substrate surface that is to be irradiated by the lithographic apparatus), the safety margin may e.g., be in an order of magnitude of 0.1-0.2 millimeters, i.e., an inner diameter of the electrode exceeding an outer diameter of the patterned or to be patterned area by 0.2-0.4 millimeters.

Several possibilities are described for handling substrate un-flatness. A possible solution is to provide that a contacting surface at which the clamp contacts the substrate surface is flatter than an average (to be expected) flatness of the to be clamped substrate. In order for the substrate to follow the flatness of the clamp, a stiffness of the clamp may exceed an average stiffness of the substrate. As an alternative, the stiffness of the clamp may be lower than an average stiffness of the to be gripped substrate, so as to allow the contacting surface of the clamp to follow a surface of the substrate. As a further possibility, the clamp may comprise at least two radial segments that are arranged to be movable independently of each other so as to follow a surface of the substrate.

The clamp may comprise an air knife so as to remove any remaining immersion liquid on the surface of the substrate, for example in immersion applications. The lithographic apparatus may be arranged to move the clamp over a part of the surface of the substrate for immersion liquid removal by the air knife.

The invention may also be embodied as a substrate handling method comprising positioning the substrate by means of a gripper on a substrate table of a lithographic apparatus, the method comprising clamping the substrate at a top side thereof by means of an electrostatic clamp of the gripper. In an embodiment, the method comprises clamping at least part of a circumferential outer zone of the substrate top surface. Still further, the invention may be embodied as a substrate handler for handling a substrate, the substrate handler comprising a gripper for gripping the substrate and positioning the substrate on a substrate table, wherein the gripper comprises an electrostatic clamp arranged to clamp the substrate at a top side thereof. It is noted that with the substrate handling method and with the substrate handler, the same or similar effects may be achieved as with the lithographic apparatus according to the invention. Also the same or similar embodiments may be provided, thereby achieving same or similar effects.

It may be beneficial to increase the friction between the gripper and the substrate so that the gripper is able to move the substrate at higher accelerations and velocities in a plane parallel to the top surface of the substrate. This can lead to faster loading and unloading of a substrate.

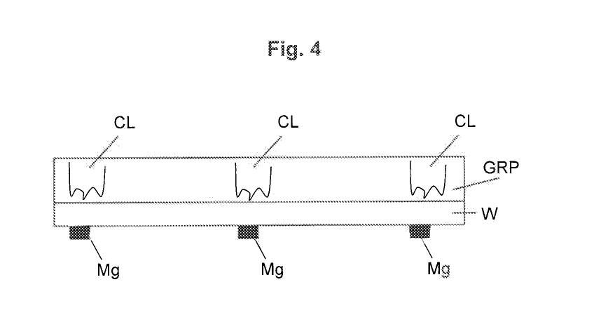

To increase the friction, the gripper may be provided with one or more coils CL, see FIG. 4. On the side of the substrate facing away from the gripper, one or more magnets Mg are provided. After the substrate is clamped to the gripper using the electro-static clamp, the coils CL are activated. This will cause the magnets to be pulled onto the bottom surface of the substrate. The magnet field created by the coils, keep the magnets on a certain location on the substrate. When the substrate is accelerated in a direction parallel to the top surface of the substrate, the friction between the magnets and the substrate prevent the substrate from slipping relative to the gripper. The magnets may have a surface with a high friction coefficient, for example a high friction coating. The magnets may be stored in a recess in the substrate table when the substrate is held by the substrate table.

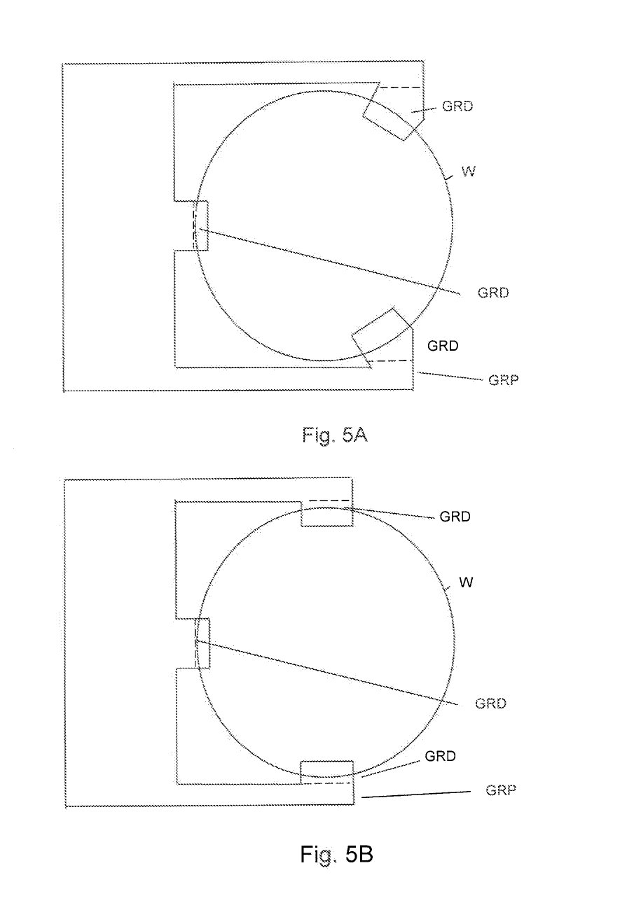

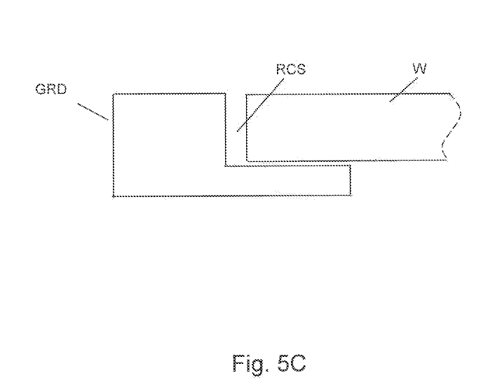

FIG. 5A depicts a top view of an edge gripper GRP according to an embodiment of the invention. The edge gripper is arranged to grip the substrate W at a bottom side edge thereof. As the edge gripper only grips a part of the edge of the substrate, a remainder of the surface of the substrate may be substantially kept free.

A temperature and temperature distribution of the substrate is a relevant parameter when the substrate is held by the gripper. During such gripping, an environment of the gripper may locally or globally change a temperature of the substrate. In accordance with the embodiment depicted in FIG. 5A however, the edge gripper only grips the substrate along a part of the edge of the substrate, so that a remainder of the surface of the substrate may be substantially kept free. A temperature of the environment may hence have a more uniform effect on the substrate, thereby possibly to a large extent avoiding a thermal fingerprint a conventional gripper may have on the substrate surface. The mechanics of the gripper may, in the embodiment depicted in FIG. 5A, have a thermal effect on the substrate at the edge only, the edge in many applications generally forming a less critical part of the substrate.

As depicted in FIG. 5A, the gripper GRP comprises 3 gripper devices GRD that hold the substrate. In FIG. 5A, the gripper devices GRD are arranged along a circumference of the substrate when held by the gripper GRP, so that a remaining thermal effect by the gripping devices on the substrate is substantially symmetrical. The gripper devices may be positioned equidistantly along the circumference of the substrate (thus in the depicted example having 3 gripper devices GRD, they may be spaced apart substantially 120 degrees) so as to provide a stable gripping. In order to facilitate a release of the gripper, two of the gripping devices GRD may be pivotable in respect of a vertical axis, so as to increase a width of a passage between them.

FIG. 5B depicts an alternative embodiment wherein the gripper devices GRD are arranged equidistantly along a half of the circumference of the substrate W, i.e., in the depicted embodiment having 3 gripper devices GRD, the gripper devices are spaced apart substantially 90 degrees. As a result, an operation of the gripper may be faster, as a slight retraction of the gripper causes the substrate to be free from the gripping devices.

FIG. 5C depicts a highly schematic side view of the gripping device. In the depicted embodiment, the gripping device GRD comprises a recess RCS arranged to accommodate an edge part of the substrate W. A gripping device part below the recess RCS has a small thickness in vertical direction (i.e., being smaller than a thickness in vertical direction of a gripping device part outside the recess RCS), so that a low maneuvering height is achieved. The larger thickness of the gripper device part outside the recess may allow for a high stiffness of the gripper. Due to the small thickness below the recess, as compared to the thickness outside the recess, a distance between (most of) the gripper and the substrate may be relatively large, causing a relatively low thermal conduction and low thermal radiation from the gripper device to the substrate. In FIGS. 5A and 5B, the recesses of the gripping devices are indicated by the dotted line. When applied to the embodiment as depicted in FIG. 5A, the recess of the gripper devices may provide for a passage having a width that is the same as or exceeds a diameter of the substrate, so as to allow for a simple release and avoid a need for a pivoting of the gripper devices or similar to allow a release.

It is noted that the gripper as explained above with reference to FIGS. 5A-5C may also be applied in combination with a top side gripper as described in other embodiments of this document. Furthermore, it is noted that the gripper as described with reference to FIGS. 5A-5C may also be applied in a vacuum or near vacuum environment, whereby similar effects may be achieved.

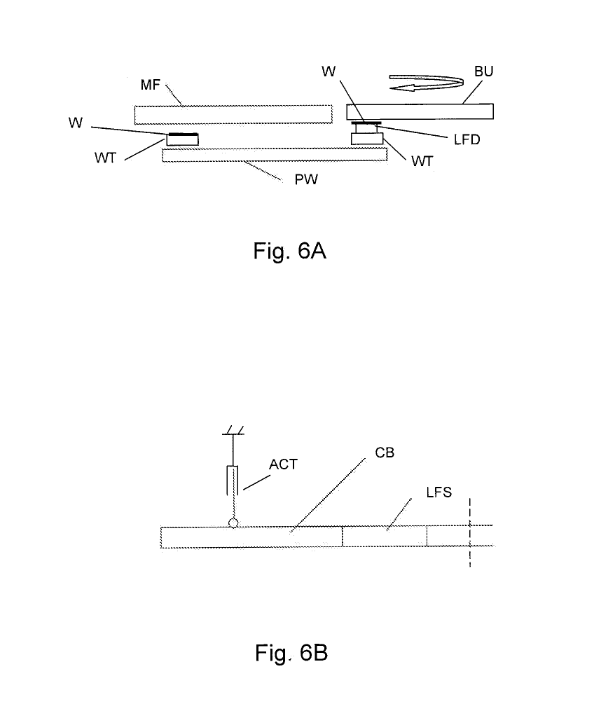

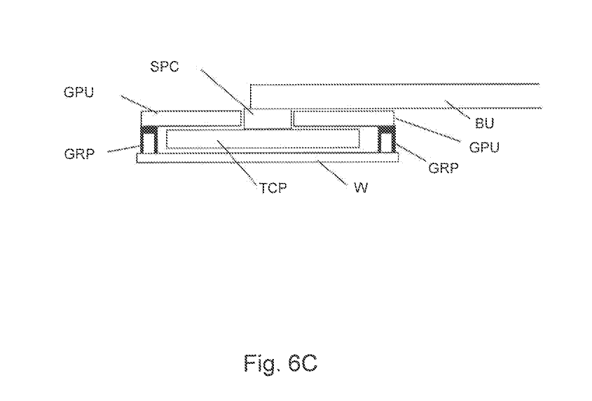

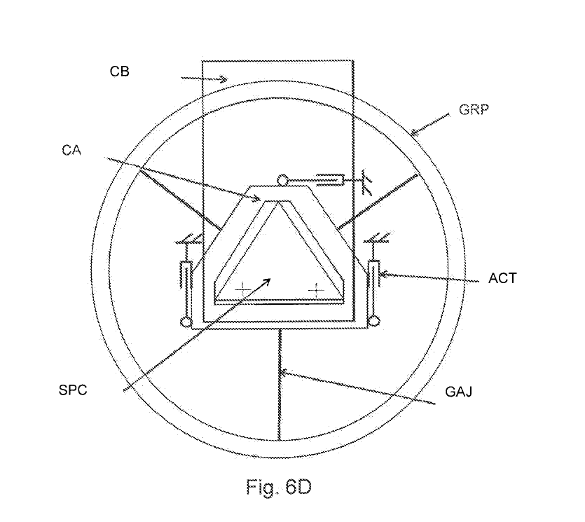

FIG. 6A depicts a highly schematic side view of a buffer BU according to an embodiment of the invention. At a lithographic apparatus, an exchange of a substrate W (e.g., a wafer) normally involves a preconditioning of the substrate on a substrate pre-aligner (the preconditioning may include temperature conditioning, positioning and orientation adjustment), transferring the substrate from pre-aligner to an end-effector, moving the end-effector plus substrate to the substrate table, accurately transferring the substrate from the end-effector to actuator pins (e.g., so called e-pins) on the substrate table, and accurately transferring the substrate from the actuator pins to the substrate table. Such a sequence implies that the substrate W may be contained in an less accurately conditioned environment for some seconds. As a result, a negative impact on overlay accuracy of the lithographic apparatus as well as on throughput of the lithographic apparatus may be obtained. The concept as will be described below with reference to FIG. 6A allows to reduce a time during which the substrate is kept in such a less accurately conditioned environment.

FIG. 6A depicts a buffer BU, in this example implemented as a carousel that is arranged for being able to rotate about a vertical center axis of rotation. The buffer comprises a gripper GRP to grip a substrate. The buffer further comprises a temperature conditioner associated with the gripper. The temperature conditioner is arranged to perform a temperature conditioning of the substrate when held by the gripper. In order to load a substrate onto the substrate table of the lithographic apparatus, the substrate is held by the buffer first, where it is temperature conditioned and transported towards the substrate table, As a result, a time during which the substrate is left in a less accurately or not conditioned environment, may be reduced. Hence, a temperature of the substrate when having been positioned on the substrate table, may be more accurate, possibly causing less undesired temperature effects in the substrate, which may provide a positive contribution overlay accuracy of the lithographic apparatus. The buffer may for example comprise a carousel to enable a first-in-first-out type buffer that may hold a plurality of substrates. The substrate table WT of the lithographic apparatus is positioned by a positioning device PW, such as a long stroke/short stroke substrate stage motor, a planar motor, etc. A range of movement of the positioning device PW extends so as to allow the substrate table to move to a position where it is able to receive a substrate from a gripper of the buffer BU. In the depicted example, the positioning device PW is arranged to position the substrate table WT outside a range of movement as defined by for example position encoder gratings on a metrology frame MF of the lithographic apparatus. In the depicted example wherein the buffer BU comprises a carousel, the substrate table WT is positioned by the positioning device to be under a part of the carousel where the substrate that is to be loaded onto the substrate table is located.

In order to load the substrate from the substrate buffer location onto the substrate table, various solutions are possible: in a first embodiment, as schematically depicted in FIG. 6A, the substrate table is provided with a lifting device LFD, such as e-pins. In order to load the substrate W onto the substrate table WT, the substrate table is positioned below the gripper of the buffer (i.e., below the substrate held by the gripper) and the e-pins are lifted. The substrate may then be released by the gripper, and consequentially supported by the lifted e-pins. The e-pins may then be lowered causing the substrate to be held by the substrate table. Alternatively, in a second embodiment, as schematically depicted in FIG. 6B, the buffer may for example comprise a lifting device, such as an actuator ACT, that allows a vertical displacement of the substrate held by the gripper. The lifting device may lower the substrate onto the substrate table. For example, the lifting device may be formed by a Z-actuator ACT, such as a Lorentz motor, that exerts a force in a vertical direction onto a part of the buffer BF, such as in the depicted example a part of the carousel body CB that is connected to a central part by means of a leaf spring LFS. As a result, the part of the carousel body on which the actuator may act, may move in respect of the central part. The actuator ACT may also be applied to load/unload a substrate from the substrate buffer location to a pre-aligner and vice versa.

FIG. 6C depicts a highly schematic side view of a part of the carousel as depicted in FIG. 6A. An edge gripper GRP is provided to grip a circumferential top side edge of the substrate, making use of for example an electrostatic or vacuum gripper as explained elsewhere in this document. Temperature conditioning is provided by a temperature conditioner plate TCP which is provided on top of the substrate W held by the gripper GRP. The temperature conditioner plate preferably comprises a temperature conditioner plate surface facing the substrate and being arranged parallel to the substrate when held by the gripper GRP to provide a substantially evenly distributed temperature conditioning of the substrate. The temperature conditioner may be provided with any suitable temperature conditioning device, such as a heater, cooler, a thermal buffer, etc. or a combination of such conditioning devices. The gripper GRP is positioned by a corresponding gripper positioning unit GPU that may e.g., comprise an piezoelectric actuator, pneumatic actuator or any other suitable type of actuator. An embodiment of the gripper positioning unit GPU will be described below with reference to FIG. 6D. The temperature conditioner plate TCP is in this example connected to a carousel body CB of the carousel by means of a spacer SPC that may provide for a thermal isolation between the temperature conditioner plate TCP and the carousel body CB.

FIG. 6D depicts a schematic top view of a part of the carousel. The edge gripper GRP is positioned by the gripper positioning unit GPU that connects the edge gripper GRP to the carousel body CB. The gripper positioning unit GPU in this example comprises 3 actuators ACT having a range of movement in horizontal direction. Gripper to actuator joints GAJ connect the edge gripper GRP to a carrier CA. The carrier CA is in this embodiment positioned (seen in vertical direction) around the spacer SPC. The actuators, of which 2 having a range of movement in a same, first horizontal direction and the third one having a range of movement in a second horizontal direction perpendicular to the first horizontal direction. An actuation of the actuator will allow the carrier CA, gripper to actuator joints GAJ and edge gripper GRP to move in respect of the spacer and carousel body CB, namely in the first and/or second horizontal direction and/or to rotate about a vertical axis (i.e., an axis perpendicular to the plane of drawing). The position of the substrate may be measured by any suitable position measurement means, such as a CCD camera, so as to adjust a position of the substrate in accordance with the position measurement.

It is noted that the carousel (or other type of buffer, such as a stack type buffer) may comprise a plurality of grippers and associated temperature conditioning devices. Likewise, for each gripper and associated temperature conditioning device, a substrate position measurement device and an actuator, such as a gripper positioning unit, may be provided so as to allow the buffer to contain a plurality of substrates, and to load them onto the substrate table of the lithographic apparatus, for example using the buffer as a first in first out type of conditioned storage.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion,” respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g., having a wavelength of or about 365, 248, 193, 157 or 126 nm) and extreme ultra-violet (EUV) radiation (e.g., having a wavelength in the range of 5-20 nm), as well as particle beams, such as ion beams or electron beams.

The term “lens,” where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g., semiconductor memory, magnetic or optical disk) having such a computer program stored therein.

### CONCLUSION

The Detailed Description section, and not the Summary and Abstract sections, is intended to be used to interpret the claims. The Summary and Abstract sections can set forth one or more but not all exemplary embodiments of the present invention as contemplated by the inventor(s), and thus, are not intended to limit the present invention and the appended claims in any way.

Various embodiments of the present invention have been described above. It should be understood that they have been presented by way of example only, and not limitation. It will be apparent to persons skilled in the relevant art that various changes in form and detail can be made from those specifically described without departing from the spirit and scope of the invention. Thus, the breadth and scope of the present invention should not be limited by any of the above-described exemplary embodiments, but should be defined only in accordance with the following claims and their equivalents.

The invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The descriptions above are intended to be illustrative, not limiting. Thus, it will be apparent to one skilled in the art that modifications may be made to the invention as described without departing from the scope of the claims set out below.

What is claimed is:

1. A lithographic apparatus arranged to transfer a pattern from a patterning device onto a substrate, the lithographic apparatus comprising:
a substrate table constructed to hold a substrate; and
a gripper arranged to position the substrate on the substrate table, the gripper comprising an electrostatic clamp arranged to clamp the substrate at a top side thereof,
wherein a stiffness of the clamp is lower than an average stiffness of the to be gripped substrate.

2. The lithographic apparatus according to claim 1, wherein the gripper comprises at least two radial segments that are arranged to be movable independently so as to follow a surface of the substrate.

3. The lithographic apparatus according to claim 1, wherein the electrostatic clamp is arranged to clamp at least part of a circumferential outer zone of the substrate top surface.

4. The lithographic apparatus according claim 1, wherein the electrostatic clamp comprises an electrode having a shape generally following at least a segment of a circle.

5. The lithographic apparatus according to claim 1, wherein the electrostatic clamp is a bipolar clamp comprising two electrodes, the electrostatic clamp being arranged for applying a substantially opposite voltage to the two electrodes.

6. The lithographic apparatus according to claim 5, wherein a dielectric layer is interposed between the or each electrode and a contacting surface of the electrostatic clamp, the contacting surface to contact the substrate.

7. The lithographic apparatus according to claim 1, wherein the clamp comprises a ground electrode, the ground electrode being provided at a side of the or each electrode facing away from the contacting surface of the clamp.

8. The lithographic apparatus according to claim 1, wherein the clamp comprises a ground electrode, the ground electrode being provided coplanar with the electrode as a concentric ring.

9. The lithographic apparatus according to claim 1, wherein the gripper further comprises an edge gripper arranged to grip the substrate at a bottom side edge thereof.

10. The lithographic apparatus according to claim 1, wherein the edge gripper comprises a plurality of gripping devices to grip the substrate at corresponding locations along a circumference of the substrate.

11. The lithographic apparatus according to claim 10, wherein the gripping devices are arranged equidistantly along a half of a circumference of the to be gripped substrate.

12. The lithographic apparatus according to claim 10, wherein each gripping device comprises a recess arranged to accommodate an edge part of the substrate, a gripping device part below the recess having a thickness in vertical direction which is smaller than a thickness in vertical direction of a gripping device part outside the recess.

13. A lithographic apparatus according to claim 1, comprising a buffer to hold the substrate before being loaded onto the substrate table, the buffer comprising:
at least one gripper being arranged to grip an edge of the substrate, and
a temperature conditioner arranged to perform a temperature conditioning of the substrate when held by the gripper.

14. The lithographic apparatus according to claim 13, further comprising:
a position measurement device arranged to measure a position of the substrate when held by the gripper, and
an actuator arranged to adjust the position of the substrate when held by the gripper.

15. The lithographic apparatus according to claim 14, wherein the buffer comprises a carousel.

16. The lithographic apparatus according to claim 15, comprising a lifting device to move the substrate when held by the gripper in a vertical direction.

17. A substrate handling method comprising positioning the substrate by means of a gripper on a substrate table of a lithographic apparatus, the method comprising clamping the substrate at a top side thereof by means of an electrostatic clamp of the gripper, wherein a stiffness of the clamp is lower than an average stiffness of the to be gripped substrate.

18. The substrate handling method according to claim 17, comprising clamping at least part of a circumferential outer zone of the substrate top surface.

19. A substrate handler for handling a substrate, the substrate handler comprising a gripper for gripping the substrate and positioning the substrate on a substrate table, wherein the gripper comprises an electrostatic clamp arranged to clamp the substrate at a top side thereof, wherein a stiffness of the clamp is lower than an average stiffness of the to be gripped substrate.

20. The substrate handler according to claim 19, wherein the electrostatic clamp is arranged to clamp at least part of a circumferential outer zone of the substrate top surface.
